(19) United States
(12) Patent Application Publication
(10) Pub. No.: US 2013/0058738 A1
(43) Pub. Date: Mar. 7, 2013

(54) PRINTING APPARATUS AND METHOD OF CONTROLLING THE SAME

(71) Applicant: Junichi Yamakawa, Hiratsuka-shi (JP)

(72) Inventor: Junichi Yamakawa, Hiratsuka-shi (JP)

(73) Assignee: CANON KABUSHIKI KAISHA, Tokyo (JP)

(21) Appl. No.: 13/551,731

(22) Filed: Jul. 18, 2012

(30) Foreign Application Priority Data
Sep. 5, 2011 (JP) 2011-193276

(51) Int. Cl. B42C 1/12

(52) U.S. Cl. 412/1; 412/13

(57) ABSTRACT

A print job for ring binding is received and page information contained in the print job is acquired. Based on the page information, it is determined whether a sheet used as a back cover in the ring binding is a sequential insert sheet whose insertion order is determined in advance. When it is determined that the sheet used as the back cover is a sequential insert sheet, control is performed such that the insert sheet used as the back cover is printed by discharging insert sheets up to the insert sheet just before the insert sheet used as the back cover out of a set of sequential insert sheets. Then, sheets used as inner sheets in the ring binding and a sheet used as a front cover in the ring binding are printed in order.

### BACKGROUND OF THE INVENTION

1. Field of the Invention

The present invention relates to a printing apparatus which prints sheets to be bound by a ring binding apparatus as well as to a method of controlling the printing apparatus.

2. Description of the Related Art

Conventionally, ring binding apparatuses are available which punch holes in printed matter with a puncher and bind the printed matter with wire rings. Particularly in recent years, in-line ring binding apparatuses connected directly with a printing apparatus and capable of directly ring-binding the printed matter have come to be put to practical use. Such in-line ring binding apparatuses include one that automatically does ring binding by replacing some pages in a ring-bound pamphlet (see, for example, Japanese Patent Laid-Open No. 2010-143072).

FIGS. 2A and 2B are diagrams showing an example of rings used for ring binding.

A ring 201 is made by bending a single wire and called a double-loop ring. The ring 201 is shaped like a letter C before binding. When the ring is caulked by application of pressure from above and below the letter C (in a left and right direction in FIG. 2A), the wire is deformed into a circular shape as shown in FIG. 2B to prevent the bound sheets from falling off.

In the case of ring binding, since caulk binding is done as described above, caulking seams 202 are visible. The caulking seams 202 are displeasing to the eye. Also, cut surfaces of the wire show at upper and lower ends, and feel unpleasant to the touch as well. Generally, to prevent the caulking seams from appearing on the back after binding, the binding is done such that the caulking seams 202 will be hidden just behind the back cover.

FIGS. 3A and 3B are schematic diagrams for illustrating a binding process in ring binding.

As shown in FIG. 3A, in the case of ring binding, a back cover 304 is printed first, a front cover 303 is printed next, and finally inner sheets 302 are printed. Next, all the sheets (back cover 304, front cover 303, and inner sheets 302) are punched with a puncher and set on a ring binding machine. Then, rings 201 are run through the punched holes and the sheets are bound by application of pressure to the rings 201 as described with reference to FIG. 2B.

Next, as shown in FIG. 3B, when the back cover 304 is turned along the rings, a desired product (bound material) made up of the front cover 303, inner sheets 302, and back cover 304 can be obtained.

FIG. 4 is a diagram illustrating paper layout in a conventional ring binding job.

It is assumed here that all the sheets are printed on both sides. To obtain a paper layout such as shown in FIG. 3A, the (N−1)th page and Nth page which correspond to the back cover 304 and then the front side (first page) and back side (second page) which correspond to the front cover 303 are printed in this order. Then, finally the front and back sides of the inner sheets 302 are printed from the third page to the (N−2)th page in order, thereby completing the first copy of an N-page pamphlet. In this case, the above operations are repeated three times to print three copies.

However, the conventional technique described above has the following problem. If, for example, the sheet corresponding to the back cover 304 is a tabbed sheet or interleaf which affects the order of sheets, it is necessary to first print the tabbed sheet or interleaf. However, the conventional technique has a problem in that sheets cannot be printed in proper order.

### SUMMARY OF THE INVENTION

An aspect of the present invention is to eliminate the above-mentioned problems with the conventional technology.

It is a feature of the present invention to provide a printing apparatus and a method of controlling the printing apparatus which can print sheets in proper order and do ring binding even if sequential insert sheets such as tabbed sheets or interleaves are used in a print job for ring binding.

According to an aspect of the present invention, there is provided a printing apparatus comprising: a reception unit configured to receive a print job for ring binding; an acquisition unit configured to acquire page information contained in the print job; a determination unit configured to determine, based on the page information, whether a sheet used as a back cover in the ring binding is a sequential insert sheet whose insertion order is determined in advance; an insert paper print control unit configured to perform control such that in a case that the determination unit determines that the sheet used as the back cover is a sequential insert sheet, the insert sheet used as the back cover is printed by discharging insert sheets up to the insert sheet just before the insert sheet used as the back cover out of a set of sequential insert sheets; and a print control unit configured to print sheets used as inner sheets in the ring binding and a sheet used as a front cover in the ring binding, in order.

According to another aspect of the present invention, there is provided a control method for controlling a printing apparatus capable of executing a print job for ring binding, the control method comprising: a reception step of receiving a print job for ring binding; an acquisition step of acquiring page information contained in the print job; a determination step of determining, based on the page information, whether a sheet used as a back cover in the ring binding is a sequential insert sheet whose insertion order is determined in advance; an insert paper print control step of performing control such that in a case that the determination step determines that the sheet used as the back cover is a sequential insert sheet, the insert sheet used as the back cover is printed by discharging insert sheets up to the insert sheet just before the insert sheet used as the back cover out of a set of sequential insert sheets; and a print control step of printing sheets used as inner sheets in the ring binding and a sheet used as a front cover in the ring binding, in order.

Further features and aspects of the present invention will become apparent from the following description of exemplary embodiments, with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram describing a binding system according to an embodiment of the present invention;

FIGS. 2A and 2B are diagrams showing an example of rings used for ring binding;

FIGS. 3A and 3B are schematic diagrams illustrating a binding process in ring binding;

FIG. 4 is a diagram illustrating paper layout in a conventional ring binding job;

FIG. 5 is a block diagram showing a configuration of a controller of a printing apparatus according to the embodiment;

FIG. 6 is a block diagram illustrating software modules of the printing apparatus according to the embodiment;

FIGS. 7A to 7C are diagrams illustrating print jobs according to the embodiment;

FIG. 8 is a flowchart for describing processes performed by a printing apparatus according to a first embodiment;

FIGS. 9A and 9B are diagrams showing output control for tabbed sheets according to the first embodiment and a second embodiment; and

FIG. 10 is a flowchart for describing processes performed by a printing apparatus according to the second embodiment.

### DESCRIPTION OF THE EMBODIMENTS

Embodiments of the present invention will be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

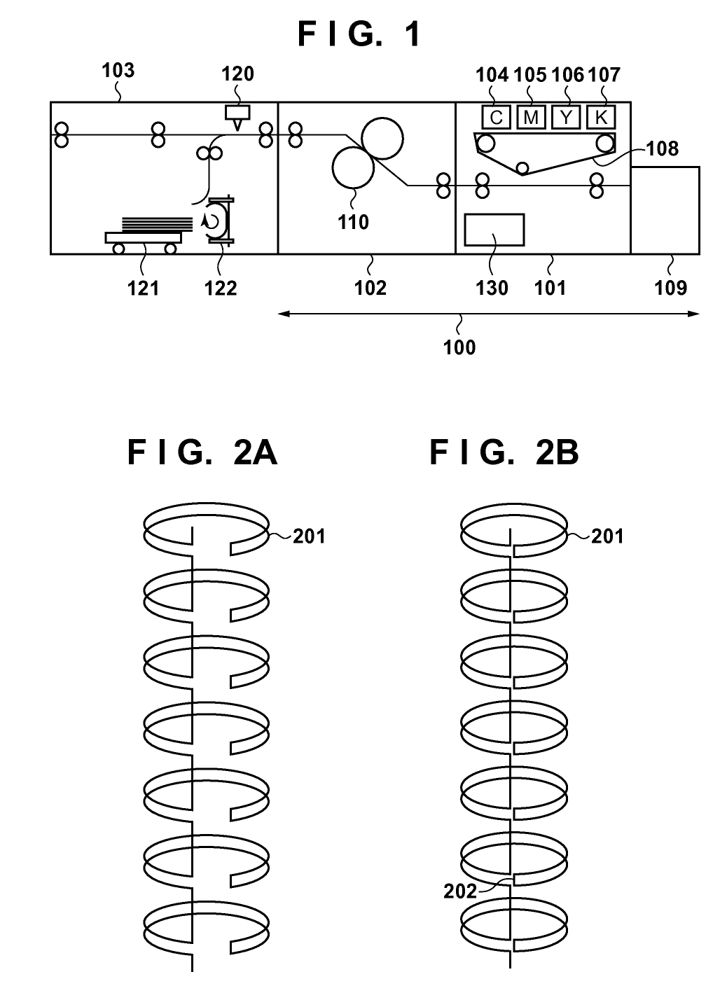

FIG. 1 is a block diagram describing a binding system according to an embodiment of the present invention.

A printing apparatus 100 includes a development station 101, a fixing station 102, and a paper supply deck 109 and is capable of performing a printing process to print sheets (printed matter) used in ring binding. A controller 130 is a control unit which controls various apparatuses. In the development station 101, an input image from the controller 130 is developed by respective CMYK developers 104 to 107, with toner being attached to images on photosensitive drums (not shown) contained in the developers. CMYK toner images thus developed are transferred to an intermediate transfer belt 108, and then transferred to a sheet supplied from the paper supply deck 109. The sheet to which the toner images have been transferred is sent to the fixing station 102. Then, heat and pressure are applied to the sheet by a fixing roller 110 and consequently the toner is melted and fixed to a sheet surface, thereby completing printing.

A ring binding apparatus 103 is connected directly to the fixing station 102 of the printing apparatus 100. The printed sheet sent from the printing apparatus 100 is inputted to the ring binding apparatus 103. In the case of a ring binding job, holes suitable for rings are punched in the sheet by a puncher 120. Next, the sheet is sent to a stack unit 121 and loaded thereon. When all sheets for one pamphlet are loaded on the stack unit 121 in this way, a ring caulking unit 122 passes the rings 201 through the holes in the stacked sheets by turning the rings 201 and does caulk binding by applying pressure from above and below the rings.

The above control allows processes from printing to ring binding to be performed automatically.

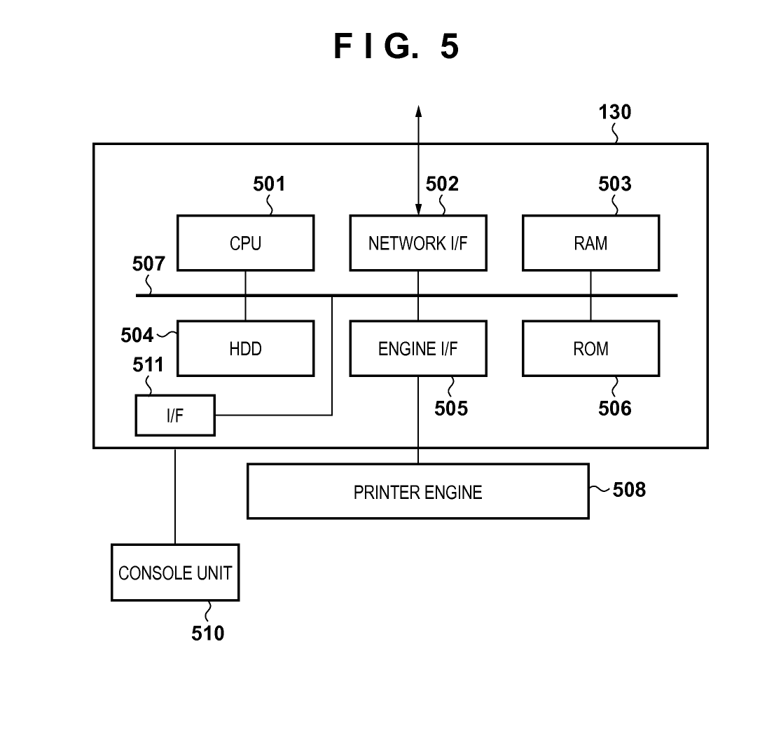

FIG. 5 is a block diagram showing a configuration of the controller 130 of the printing apparatus 100 according to the embodiment of the present invention.

The controller 130 has the following configuration. Via a system bus 507, a central processing unit (CPU) 501 controls various parts of the apparatus, performs computations, and executes programs stored in a storage device. A random access memory (RAM) 503 is used as a temporary storage area and working memory during operation of the printing apparatus 100. A hard disk drive (HDD) 504 is a large-capacity storage device and stores various control programs executed by the CPU 501. Also, the HDD 504 is used as a temporary storage area for data being processed. A ROM 506 is a storage device which stores a boot program of the printing apparatus 100. A network interface (I/F) 502 communicates with other apparatuses such as a host computer via an external network interface (I/F). An engine interface (I/F) 505 communicates with, and controls, a printer engine 508. Incidentally, the printer engine 508 includes the development station 101, fixing station 102, and the like shown in FIG. 1. A console unit 510 is connected via a console unit interface 511 and equipped with a touch panel, various hard keys, and the like operated by a user.

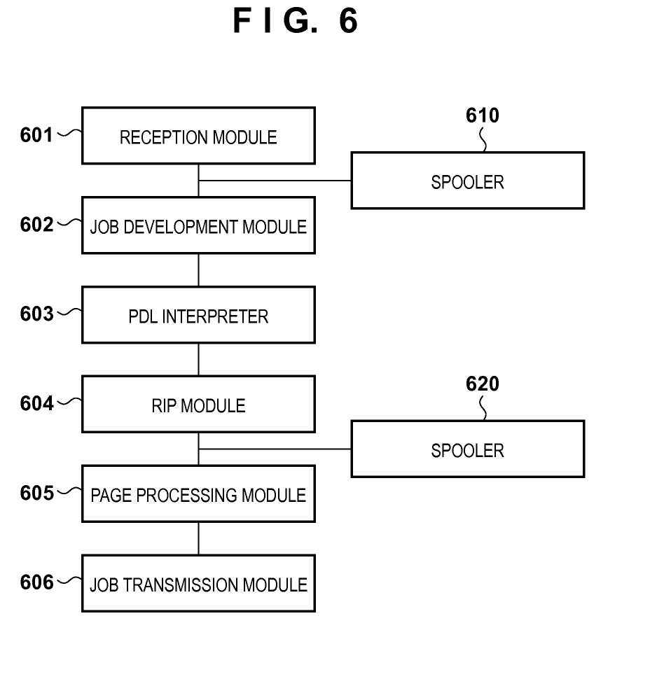

FIG. 6 is a block diagram illustrating software modules of the printing apparatus 100 according to the embodiment of the present invention.

The software modules are executed by the CPU 501 when invoked by a program loaded into the RAM 503. A job reception module 601 receives a print job via the network interface (I/F) 502 and temporarily stores the print job in a spooler 610. A job development module 602 analyzes and develops the received print job and passes the print job to a PDL interpreter 603. The PDL interpreter 603 develops PDL (Page Description Language) data contained in the print job and converts the PDL data into an intermediate data format. The PDL data here is, for example, in Adobe Systems' PDF (Portable Document Format).

A RIP module 604 receives the intermediate data resulting from the conversion, converts the intermediate data into image data via RIP (raster image processing), and temporarily stores the image data in a spooler 620. A page processing module 605 rearranges the page sequence of the image data stored in the spooler 620. A job transmission module 606 outputs the rearranged image data to the printer engine 508 via the engine interface 505 in order for the image data to be printed. The spoolers 610 and 620 may be either loaded in the RAM 503 or installed on the HDD 504.

Next, a control process by a printing apparatus 100 according to a first embodiment will be described.

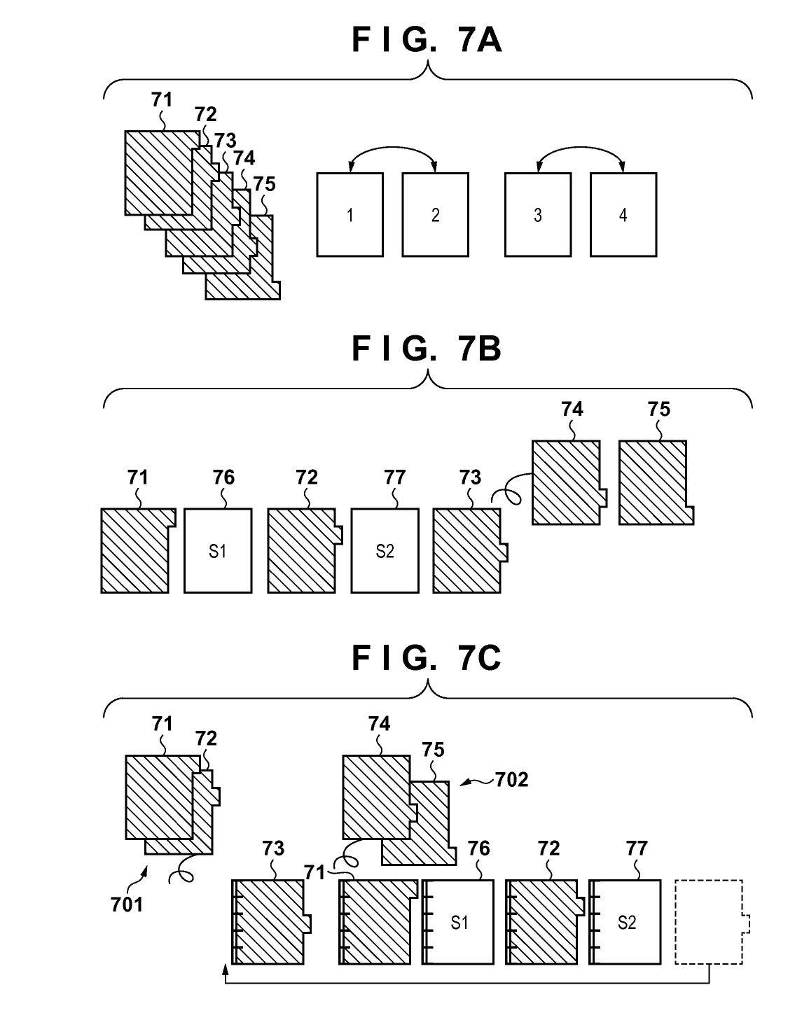

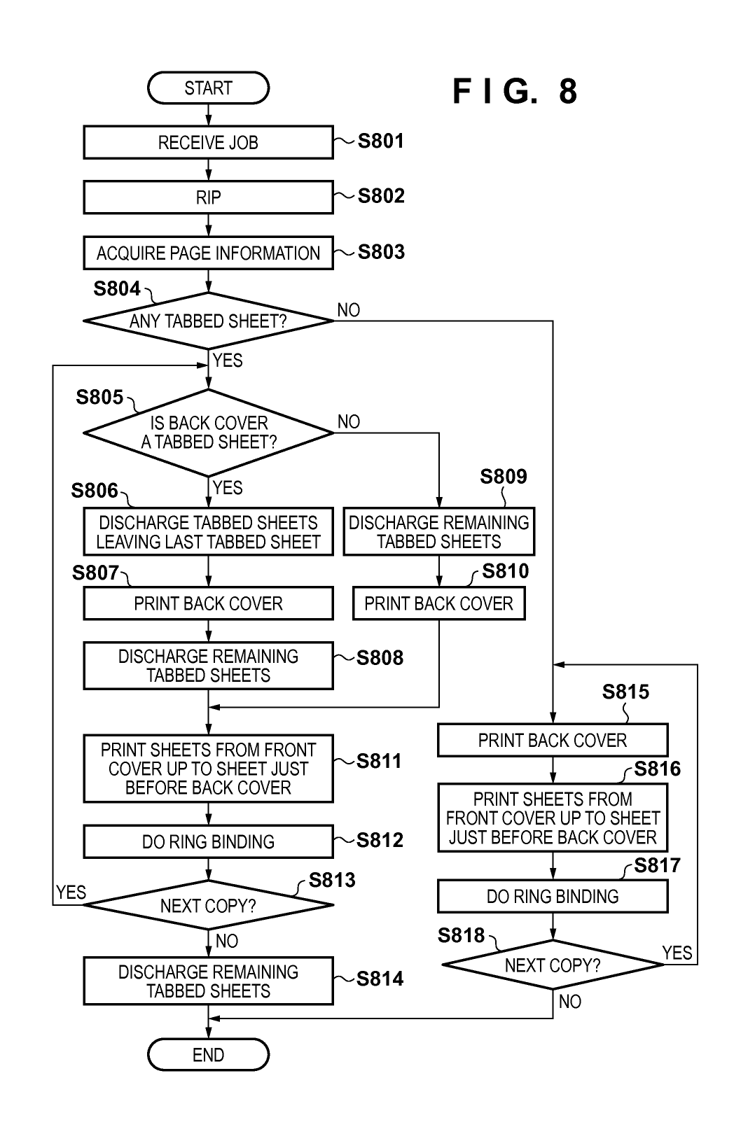

FIGS. 7A to 7C are diagrams illustrating print jobs according to the embodiment. The figures illustrate sheet control for ring binding associated with a print job which involves the use of tabbed sheets. The tabbed sheets are cited here as an example of sequential insert sheets whose insertion order is determined in advance according to, for example, locations of tabs.

In FIG. 7A, sets of five tabbed sheets 71 to 75 are used. A first tabbed sheet 71 has a tab at the highest location, a second tabbed sheet 72 has a tab at a lower location from the first tabbed sheet 71, a third tabbed sheet 73 at a still lower location and a fourth tabbed sheet 74 at a yet lower location, and a fifth tabbed sheet 75 has a tab at the lowest location. A required number of tabbed sheets are loaded on a paper tray in sets of five with the tabbed sheets 71, 72, 73, 74, and 75 being arranged from top to bottom as shown in FIG. 7A. Regarding inner sheets printed in the print job, four pages (1 to 4 in FIG. 7A) of data are printed on two sheets in the case of duplex printing.

FIG. 7B shows a print job with tabbed sheets inserted. Reference numerals 71 and 72 denote printed tabbed sheets. Reference numeral 76 denotes a sheet (S1) both sides of which are printed as the first page (“1” in FIG. 7A) and second page (“2” in FIG. 7A), respectively, and reference numeral 77 denotes a sheet (S2) both sides of which are printed as the third page (“3” in FIG. 7A) and fourth page (“4” in FIG. 7A), respectively.

In this case, the job uses three tabbed sheets (71, 72 and 73) and two inner sheets (76 and 77). As described with reference to FIG. 7A, since tabbed sheets are used in sets of five, each time a copy is outputted, two unused tabbed sheets (74 and 75) are left over and discharged.

FIG. 7C is a diagram showing a printing sequence of sheets in the above-described job followed by ring binding. Since the last tabbed sheet in FIG. 7B is 73, after the tabbed sheets 71 and 72 are discharged in 701, the tabbed sheet 73 is printed first as the back cover. To print the tabbed sheet 71 next as the front cover, it is necessary to discharge the tabbed sheets 74 and 75 in 702 by performing the process of discharging the remaining tabbed sheets. Then the tabbed sheet 71 of the second set is supplied and printed. Then, the sheet (S1), tabbed sheet 72, and sheet (S2) are printed in order, and the sheets are ring-bound.

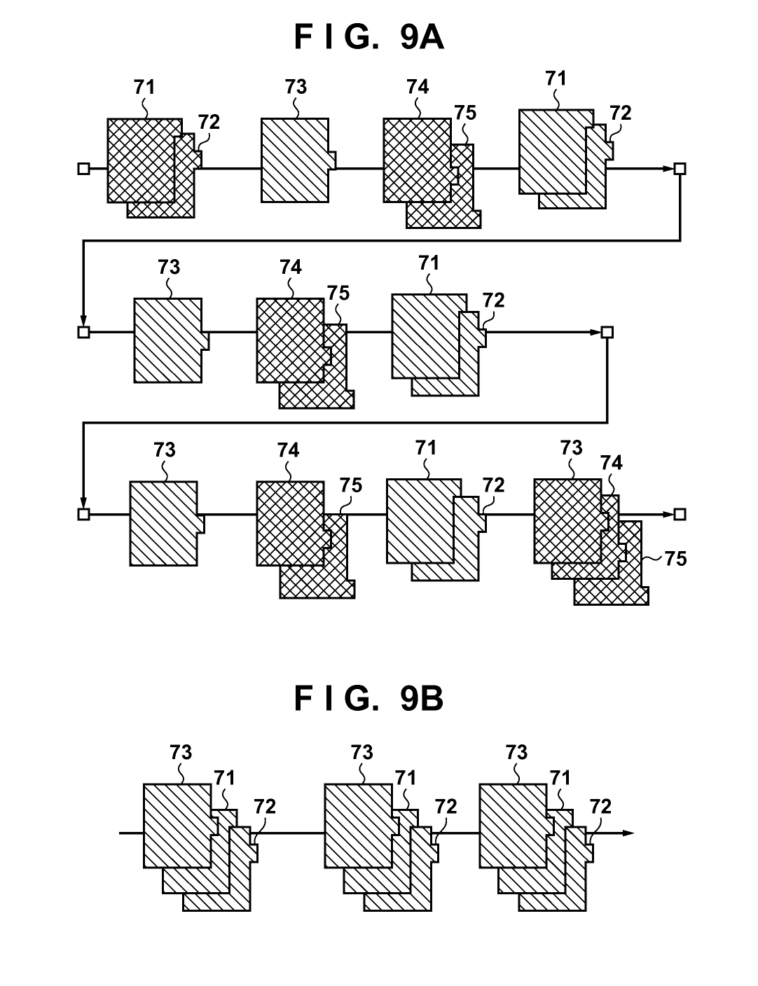

FIG. 8 is a flowchart for describing processes performed by the printing apparatus 100 according to the first embodiment. A program which performs the processes is loaded, for example, from the HDD 504 into the RAM 503 during execution and executed under the control of the CPU 501.

In the case of printing for a ring binding job, first in step S801, the controller 130 is started and the network I/F 502 receives print job data. Next, the program advances to step S802, in which the job development module 602 sends the print job received in step S801 to the PDL interpreter 603 and the RIP module 604 generates image data from intermediate data generated by the PDL interpreter 603 and stores the image data in the spooler 610. Next, the program advances to step S803, in which the page processing module 605 analyzes sheet layout of the received print job data.

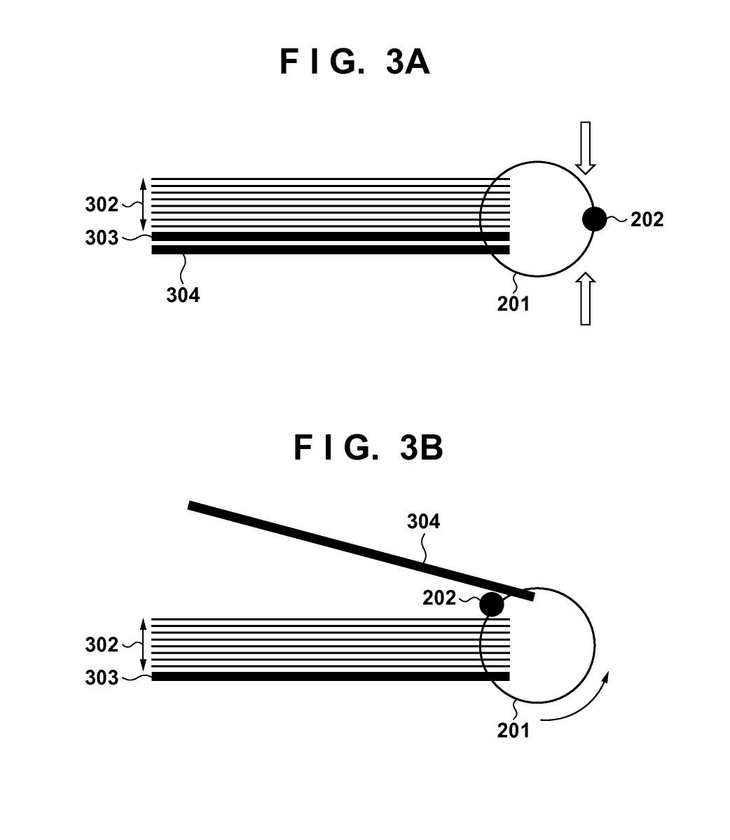

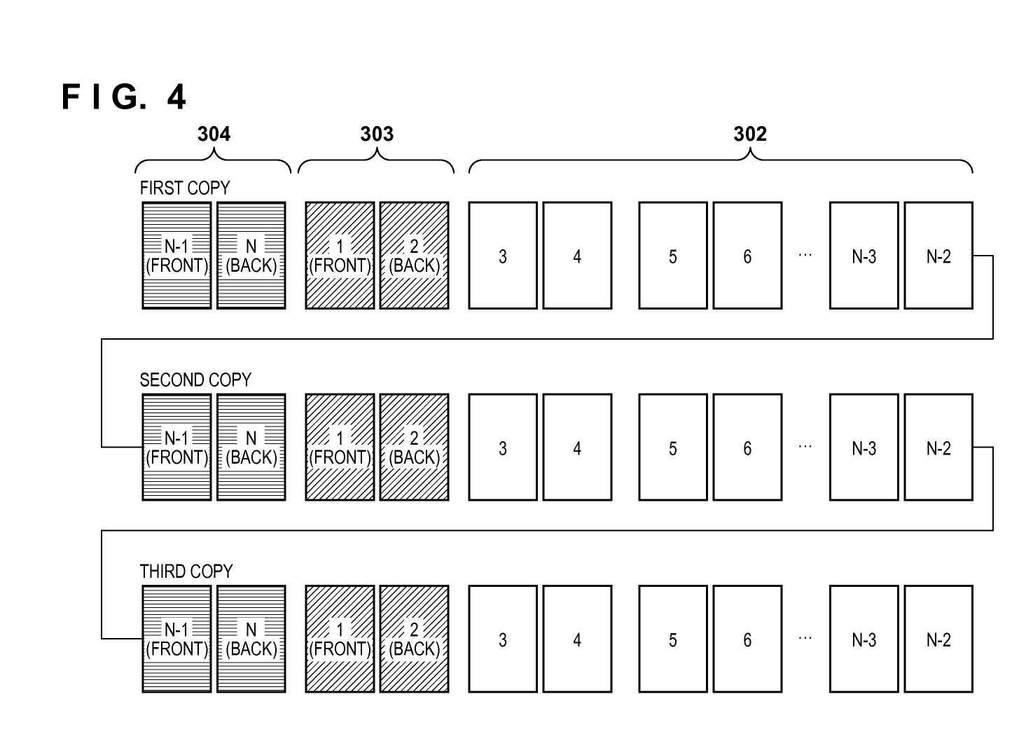

In step S804, the program determines whether the received print job involves the use of tabbed sheets. If it is determined that the job does not involve the use of tabbed sheets, the program advances to step S815. If it is determined that the job involves the use of tabbed sheets, the program advances to step S805. The processes of steps S815 to S818 are similar to conventional ones. That is, in a ring-binding print job which does not involve the use of tabbed sheets, after printing the back cover, the page processing module 605 goes to step S816 to print the sheets from the front cover up to the sheet just before the back cover. Then, the program advances to step S817, in which the controller 130 ring-binds the printed sheets by controlling the ring binding apparatus 103. This completes ring binding such as shown in FIG. 3A. Next, in step S818, it is determined whether there is another copy. If there is, the program returns to step S815 to repeat processing. When the last copy has been processed, the program finishes the processing.

On the other hand, if the job involves the use of tabbed sheets, the program advances to step S805 from step S804, in which the page processing module 605 checks insertion positions of the tabbed sheets in the received print job and determines whether the back cover is a tabbed sheet. If the back cover is a tabbed sheet, the program advances to step S806. If the back cover is not a tabbed sheet, the program advances to step S809. In step S806, to print the tabbed sheet used as the back cover, the program discharges tabbed sheets from a tabbed-sheet supply unit, beginning with the top tabbed sheet and ending with the tabbed sheet immediately preceding the tabbed sheet used as the back cover (this step corresponds to 701 in FIG. 7C).

For example, in the print job shown in FIG. 7B, since the third tabbed sheet (the tabbed sheet 73 with its tab at the third highest location) is used as the back cover, the page processing module 605 discharges the first tabbed sheet 71 and second tabbed sheet 72 to an escape tray (not shown). Next, the program advances to step S807 to print the third tabbed sheet as the back cover. Next, the program advances to step S808, in which the page processing module 605 discharges the fourth tabbed sheet and fifth tabbed sheet (74 and 75 in FIGS. 7B and 7C) in order to make the top tabbed sheet available for use (this step corresponds to 702 in FIG. 7C). Then, the program advances to step S811.

On the other hand, in step S809, if the top one of the tabbed sheets which are loaded on the tabbed-sheet supply unit and used in the print job is not the first tabbed sheet, the page processing module 605 discharges the remaining tabbed sheets. Next, the page processing module 605 advances to step S810 to print the back cover, and then advances to step S811.

In step S811, the page processing module 605 prints the sheets from the front cover up to the sheet just before the back cover. That is, in the example of FIGS. 7B and 7C, the page processing module 605 prints the first tabbed sheet 71, S1 (76), the second tabbed sheet 72, and S2 (77). Next, the program advances to step S812, in which the controller 130 ring-binds the printed sheets by controlling the ring binding apparatus 103. The program advances to step S813, in which the page processing module 605 determines whether the printed copy is the last copy. If it is determined that this is the last copy, the program advances to step S814 to discharge the remaining tabbed sheets, and then finishes processing. If it is determined in step S813 that this is not the last copy, the program returns to step S805 to repeat the processes described above.

As described above, in a ring-binding print job, by controlling the page printing order according to the type of back cover, the first embodiment allows ring binding to be done using tabbed sheets or interleaves.

### Second Embodiment

The above-described first embodiment, which begins by printing the back cover, frequently requires discharging the tabbed sheets not used in the print job. FIG. 9A shows an output pattern of tabbed sheets produced when three copies are printed for ring binding in a print job similar to the one shown in FIG. 7A. In FIG. 9A, the tabbed sheets not used in the print job are indicated by cross-hatching while the tabbed sheets used in the print job are indicated by hatching. In this way, the first embodiment uses sets of tabbed sheets equal in number to the number of copies plus 1 and discharges tabbed sheets a number of times equal to the number of copies plus 2. It takes time to change from the process of supplying tabbed sheets from the tabbed-sheet supply unit to the process of supplying tabbed sheets from a regular sheet supply unit. Therefore, when a relatively small number of copies are printed, printing efficiency becomes far lower than in the case of a job which does not involve the use of tabbed sheets.

Thus, in a second embodiment, a notification of the order of tabbed sheets used in the print job is provided before printing is started, and ring binding is done without discharging remaining tabbed sheets. FIG. 9B shows the order of tabbed sheets stored in the tabbed-sheet supply unit in the print job of FIG. 7A. In this case, tabbed sheets are set, being arranged in the order: the third tabbed sheet 73, first tabbed sheet 71, and second tabbed sheet 72. Incidentally, in the second embodiment, the configuration of the printing apparatus 100 as well as connections and configurations of the ring binding apparatus and the like are the same as in the first embodiment described above, and thus description thereof will be omitted.

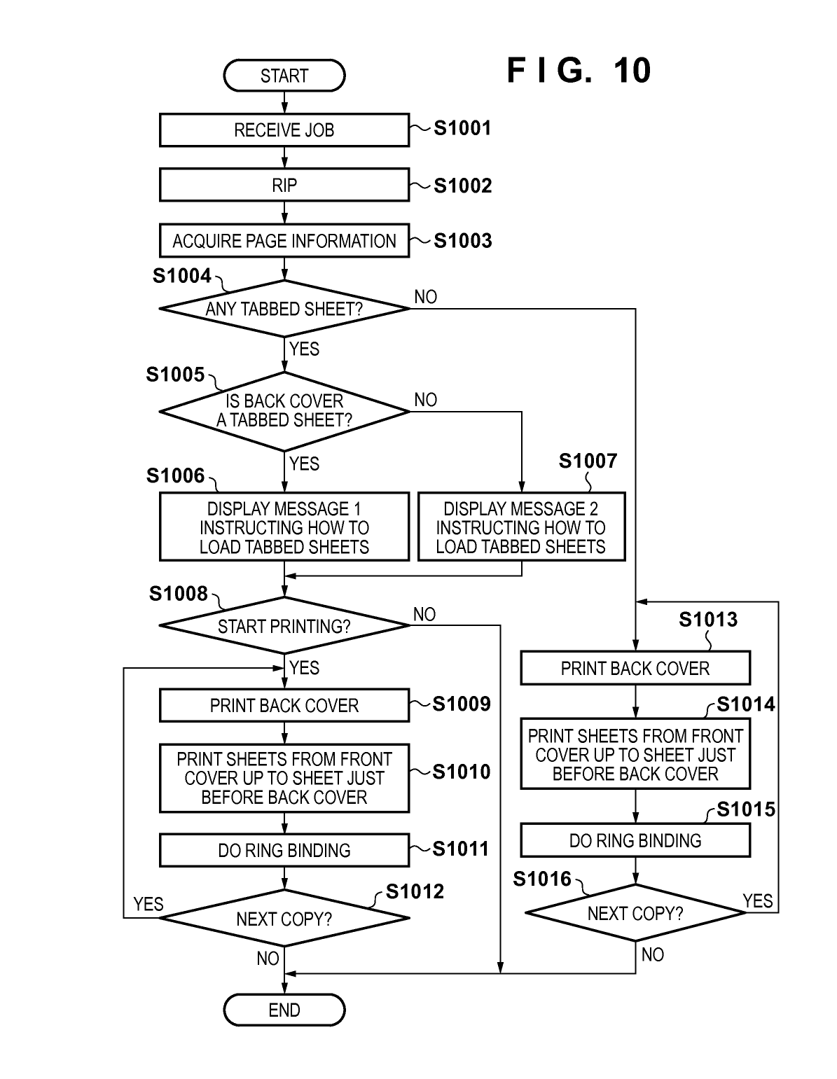

FIG. 10 is a flowchart for describing a control process for the printing apparatus 100 according to the second embodiment of the present invention. A program which performs the process is loaded, for example, from the HDD 504 into the RAM 503 during execution and executed under the control of the CPU 501.

In the case of printing for a ring binding job, first in step S1001, the controller 130 starts processing and the network I/F 502 receives print job data. Next, the program advances to step S1002, in which the job development module 602 sends the received print job to the PDL interpreter 603 and the RIP module 604 generates image data from intermediate data generated by the PDL interpreter 603 and stores the image data in the spooler 610. Next, the program advances to step S1003, in which the page processing module 605 analyzes sheet layout of the received print job data and acquires page information about the print job.

Next, the program advances to step S1004 to determine whether the print job involves the use of tabbed sheets. If it is determined that the use of tabbed sheets is involved, the program advances to step S1005. If it is determined that the use of tabbed sheets is not involved, the program advances to step S1013. The processes of steps S1013 to S1016 are the same as the processes of steps S815 to S818 in FIG. 8 described above, and thus description thereof will be omitted.

In step S1005, the page processing module 605 checks insertion positions of the tabbed sheets in the print job and determines whether the back cover is a tabbed sheet. If the back cover is a tabbed sheet, the program advances to step S1006. Otherwise, the program advances to step S1007. In step S1006, based on sheet layout analysis results produced in step S1003, the controller 130 displays a message on the console unit 510 of the printing apparatus 100, instructing how to load the tabbed sheets, and then advances to step S1008.

In the example of the print job in FIG. 7A, a message is displayed, stating, “Insert N sets of tabbed sheets by arranging the tabbed sheets in each set in the order 73-71-72. Remove the tabbed sheets 74 and 75 in advance.” N is the number of copies produced in the print job.

On the other hand, in step S1007, based on the sheet layout analysis results produced in step S1003, the controller 130 displays a message on the console unit 510 of the printing apparatus 100, instructing how to load the tabbed sheets, and then advances to step S1008. In step S1007, there is no need to change the sequence of the tabbed sheets, but the tabbed sheets not used in the job are instructed to be removed in advance. For example, in the example of FIG. 7A, a message is displayed, stating, “Insert N sets of tabbed sheets in the normal order and remove the tabbed sheets 74 and 75 in advance.”

In step S1008, the program determines whether a command to start printing has been given. If OK is selected on the console unit, giving a command to start printing, the program advances to step S1009. If Cancel is selected, the program finishes the processing. In step S1009, the page processing module 605 prints the third tabbed sheet 73 as the back cover. Next, the page processing module 605 advances to step S1010 to print the sheets from the front cover up to the sheet just before the back cover. That is, as shown in FIG. 7C, the page processing module 605 prints the first tabbed sheet 71, S1 (76), the second tabbed sheet 72, and S2 (77). Next, the program advances to step S1011, in which the controller 130 ring-binds the printed sheets by controlling the ring binding apparatus 103. In step S1012, the page processing module 605 determines whether the printed copy is the last copy. If this is the last copy, the page processing module 605 finishes processing. If this is not the last copy, the page processing module 605 returns to step S1009 to repeat the processes described above.

The above-described first embodiment, which eliminates the need to set the tabbed sheets manually, is suitable for ring binding a large number of copies.

On the other hand, the second embodiment, which requires efforts to set tabbed sheets, but eliminates the process of discharging the tabbed sheets, can reduce the time required for printing. Besides, the user may be allowed to select between the method according to the first embodiment and the method according to the second embodiment on the console unit of the printing apparatus 100 or a client computer.

The present embodiment provides the advantage of being able to print sheets in proper order and do ring binding even if sequential insert sheets such as tabbed sheets or interleaves are used in a print job for ring binding.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-193276, filed Sep. 5, 2011, which is hereby incorporated by reference herein in its entirety.

What is claimed is:

1. A printing apparatus comprising:
a reception unit configured to receive a print job for ring binding;
an acquisition unit configured to acquire page information contained in the print job;
a determination unit configured to determine, based on the page information, whether a sheet used as a back cover in the ring binding is a sequential insert sheet whose insertion order is determined in advance;
an insert paper print control unit configured to perform control such that in a case that the determination unit determines that the sheet used as the back cover is a sequential insert sheet, the insert sheet used as the back cover is printed by discharging insert sheets up to the insert sheet just before the insert sheet used as the back cover out of a set of sequential insert sheets; and
a print control unit configured to print sheets used as inner sheets in the ring binding and a sheet used as a front cover in the ring binding, in order.

2. The printing apparatus according to claim 1, wherein the sheet used as the front cover in the ring binding and the insert sheet used as the back cover are taken from different sets of sequential insert sheets.

3. The printing apparatus according to claim 1, further comprising a discharge unit configured to discharge the sheets subsequent to the insert sheet used as the back cover from the set of sequential insert sheets if the insert sheet used as the back cover is not the last sheet in the set.

4. The printing apparatus according to claim 1, wherein the sequential insert sheets are tabbed sheets or interleaves.

5. A printing apparatus comprising:
a reception unit configured to receive a print job for ring binding;
an acquisition unit configured to acquire page information contained in the print job;
a determination unit configured to determine, based on the page information, whether a sheet used as a back cover in the ring binding is a sequential insert sheet whose insertion order is determined in advance;
an instructing unit configured to give an instruction in a case that the determination unit determines that the sheet used as the back cover is a sequential insert sheet, the instruction unit instructing the insert sheet, sheets used as inner sheets in the ring binding, and a sheet used as a front cover in the ring binding to be set in order according to a printing sequence; and
a print control unit configured to print the sheets in the order specified by the instructing unit.

6. The printing apparatus according to claim 5, wherein the sequential insert sheet is a tabbed sheet or an interleaf.

7. A control method for controlling a printing apparatus capable of executing a print job for ring binding, the control method comprising:
a reception step of receiving a print job for ring binding;
an acquisition step of acquiring page information contained in the print job;
a determination step of determining, based on the page information, whether a sheet used as a back cover in the ring binding is a sequential insert sheet whose insertion order is determined in advance;
an insert paper print control step of performing control such that in a case that the determination step determines that the sheet used as the back cover is a sequential insert sheet, the insert sheet used as the back cover is printed by discharging insert sheets up to the insert sheet just before the insert sheet used as the back cover out of a set of sequential insert sheets; and
a print control step of printing sheets used as inner sheets in the ring binding and a sheet used as a front cover in the ring binding, in order.
